(19) United States
(12) Patent Application Publication
(10) Pub. No.: US 2024/0417902 A1
(43) Pub. Date: Dec. 19, 2024

(54) SPUNBOND NONWOVEN FABRIC

(71) Applicant: Carl Freudenberg KG, Weinheim (DE)

(72) Inventors: Arun Prasad VENUGOPAL, Weinheim (DE); William HUANG, Zhongli District Taoyuan city (TW); Walter TSENG, Dayuan District Taoyuan city (TW); Huan Hsiang LIN, Chungli Dist. Taoyuan (TW); Pai Chien WEI, Zhonghe Dist. New Taipei city (TW); Kenta NAKANISHI, Zhongzhan Dist. Taipei City (TW)

(21) Appl. No.: 18/336,102

(22) Filed: Jun. 16, 2023

(51) Int. Cl. D04H 3/16; B32B 5/02; B32B 5/26; B32B 7/12; B32B 27/36; D04H 3/011; D04H 3/018

(52) U.S. Cl. CPC D04H 3/16; B32B 5/022; B32B 5/267; B32B 7/12; B32B 27/36; D04H 3/011; D04H 3/018; B32B 2250/02; B32B 2250/244; B32B 2307/10; B32B 2307/304; B32B 2307/718; B32B 2307/7376; D10B 2331/04; D10B 2401/041

(57) ABSTRACT

A spunbond nonwoven fabric includes hollow polymeric multicomponent fibers. The spunbond nonwoven fabric has a thickness of at least 1 mm. The thickness of the spunbond nonwoven fabric is according to DIN EN ISO 9073-2:1997-02. The spunbond nonwoven fabric may have a thickness according to DIN 9073-2/1997 in the range of 1 to 25 mm.

### FIELD

The invention relates to spunbond nonwoven fabrics, to a method for preparation thereof, a nonwoven laminate comprising the spunbond nonwoven fabrics and moulded articles comprising such nonwoven laminates.

### BACKGROUND

Shaped articles for various applications can be obtained by moulding nonwoven laminates. Such articles are suitable for automotive, marine, aerospace, geotextiles and rail vehicle applications where lightweight parts are required which have high stability and durability, such as underbody shields for vehicles.

EP 3 769 954 A1 discloses a nonwoven laminate and moulded articles produced therefrom which can be used as underbody shields for vehicles. The nonwoven laminates comprise three to five layers of nonwoven fabrics, which are melt-bonded to each other. The structure is characterized by a needled staple fiber nonwoven layer, which is enclosed between two outer spunbond nonwoven layers. The layers are basically formed from polyethylene terephthalate (PET) fibers and copolyester fibers for melt-bonding. The moulded articles produced by moulding such nonwoven laminates have high mechanical stability and provide acoustic shielding.

US 2016/0288451 A1 discloses nonwoven composites, which are mouldable and can be used for producing vehicle underbodies. The nonwoven composites comprise a layer of needled stapled polyester fibers and layers of spun-bond polyester fibers, which are mechanically bonded to each other by needling.

US 2018/0251924 A1 relates to a nonwoven composite, which can be used for various applications. The composite is characterized by comprising specific hydrophobic PET fibers and polyalkylsiloxane-based or per-fluorinated additives.

However, known nonwoven composites and moulded articles obtained therefrom can still be improved. For use in the automotive industry, challenging internal standards have to be met regarding mechanical stability and durability. This ensures that the products are suitable for long-term use without deterioration and loss of advantageous properties. Structural automotive parts, such as underbody shields, wheel arch liners or engine shields, are exposed to mechanical stress and strain over long-time periods. They should maintain their integrity and properties even after long-term use under challenging conditions. Structural parts for vehicles must also have resistance against stone-chipping, which occurs continuously during standard use and causes high mechanical strain.

### SUMMARY

In an embodiment, the present disclosure provides a spunbond nonwoven fabric, comprising hollow polymeric multicomponent fibers, wherein the spunbond nonwoven fabric has a thickness according to DIN EN ISO 9073-2:1997-02 of at least 1 mm.

### BRIEF DESCRIPTION OF THE DRAWINGS

Subject matter of the present disclosure will be described in even greater detail below based on the exemplary FIGURES. All features described and/or illustrated herein can be used alone or combined in different combinations. The features and advantages of various embodiments will become apparent by reading the following detailed description with reference to the attached drawings, which illustrate the following:

FIG. 1 illustrates a comparison of acoustic absorption (DIN ISO 10534-1) between needled staple fabric and hollow bicomponent spunbond fabric.

### DETAILED DESCRIPTION

In an embodiment, the present invention provides a novel material which at least partially overcomes the drawbacks encountered in the art. Improved products should be provided, which are suitable for structural parts, especially for use in vehicles. The products should have high mechanical stability, yet be lightweight and should be suitable for long-term use. Preferably, the materials should also have good acoustic properties and be recyclable.

It is in particular desired that the moulded articles have a low weight. Needle punched staple fibers are indeed more voluminous and therefore they could give the moulded article more lightness. However, they have the disadvantage that they do not have good mechanical properties, such as spunbond fibers. In addition, needle punched staple fibers have a very long and therefore cost-intensive manufacturing process. Spunbond fibers, on the other hand, have good mechanical properties but are not bulky and the fibers are smooth.

It is therefore desirable to provide a nonwoven fabric that is voluminous and thus give the moulded articles a lightness without sacrificing good mechanical properties.

It is advantageous if the materials can be produced and shaped in a simple and convenient method. The materials should be available at low costs and by standard processing methods.

Surprisingly, it was found that the foregoing advantages are be achieved by spunbond nonwoven fabrics and moulded articles according to embodiments of the present invention.

An embodiment of the invention provides a spunbond nonwoven fabric, comprising hollow polymeric multicomponent fibers, wherein the spunbond nonwoven fabric has a thickness according to DIN EN 9073-2/1997-02 of at least 1 mm. In a preferred embodiment, the spunbond nonwoven fabric has a thickness according to DIN EN 9073-2/1997-02 in the range of 1 to 25 mm, preferably 2 to 16 mm, in particular 4 to 10 mm.

An embodiment of the invention further provides a method for the preparation of the spunbond nonwoven fabric as defined herein, wherein hollow multicomponent fibers are employed, comprising at least one hollow polymeric fiber as defined above and below, preferably wherein the spunbond nonwoven fabric is prepared by melt or solution spinning of the hollow multicomponent fibers through a spinneret comprising a pattern of orifices, wherein one single fiber is formed by passing the polymer melt through a spinneret having a hollow portion, especially wherein the fibers exiting the spinneret are subjected to a one step drawing process.

An embodiment of the invention further provides a nonwoven laminate, comprising layers in order (A), (B), (A):
a spunbond nonwoven fabric layer (A), comprising hollow polymeric multicomponent fibers, wherein the spunbond nonwoven fabric has a thickness according DIN EN ISO 9073-2:1997-02 of at least 1 mm;
an adhesive layer (B);
   a further spunbond nonwoven fabric layer (A) comprising hollow polymeric multicomponent fibers, preferably bicomponent fibers, wherein the spunbond nonwoven fabric has a thickness according to DIN EN ISO 9073-2:1997-02 from at least 1 mm.

The layers A employed in the nonwoven laminate can be identical or different. However, in every case the general definition of the nonwoven fabric is fulfilled.

An embodiment of the invention further provides a moulded article comprising a spunbond nonwoven fabric as defined above and below or a laminate as defined above and below.

An embodiment of the invention further provides a structural part for vehicles which comprises a moulded article as defined above and below, wherein the structural part is preferably an underbody shield, wheel arch liner or engine shield.

An embodiment of the invention further provides a vehicle comprising a moulded article and/or structural part as defined above and below.

An embodiment of the invention further provides for the use of a moulded article as defined above and below for applications in the automotive, marine, aerospace and rail vehicle sector, in particular as a structural part for vehicles, wherein the structural part is preferably an underbody shield, wheel arch liner or engine shield.

### Spunbond Nonwoven Fabric:

An embodiment of the invention provides a spunbond nonwoven fabric, comprising hollow polymeric multicomponent fibers, wherein in that the spunbond nonwoven fabric has preferably a thickness according to DIN EN ISO 9073-2:1997-02 from 1 mm to 25 mm, more preferably 2 mm to 16 mm, in particular 4 mm to 8 mm.

As used herein, the term nonwoven relates to a nonwoven fabric. This is a layer of fibers, which are consolidated by physical and/or chemical means, excluding weaving, knitting or paper making. In general, a nonwoven fabric is defined by DIN EN ISO 9092:2018.

A spunbond generally refers to a fabric comprising theoretically endless fibres which are drawn from molten fibre raw material. It is preferred that spunbond nonwoven layers (A) are made of continuous filament calendared together in the form of a sheet.

A multicomponent fiber comprises at least two (like 2, 3, 4, 5 or more) different polymer components. Preferred are multicomponent fibers consisting of two polymer components (bicomponent fibers). Suitable types of bicomponent fibers are sheath/core fibers (also denoted as core/shell fibers), side-by-side fibers, islands-in-the-sea fibers and pie piece fibers.

In an embodiment, the multicomponent fibers consist of at least two different polymers, the melting point of one polymer preferably being at least 10° C., more preferably at least 20° C., higher than that of a second polymer also present in the fibers.

In a further embodiment, the multicomponent fibers comprise or consist of core/sheath fibers, with the material of the core having the higher melting point and the material of the sheath having the lower melting point.

A preferred bicomponent fiber contains two polymer components selected from two different polyesters. Particularly preferred, the two different polyesters are selected from polyethylene terephthalate (PET), co-polyethylene terepthalates (Co-PET), polyethylene naphthalate (PEN), polybutylene terephthalate (PBT), co-butylene terephthalate (Co-PBT), polylactic acid (PLA), poly(ethylene succinate) (PES), poly(butylene succinate) (PBS), poly(ethylene adipate) (PEA), poly(butylene succinate-co-butylene adipate) (PBSA), polyhydroxyacetic acid (PGA), poly(butylene succinate-co-butylene sebacate) (PBsu-co-BSe), poly(butylene succinate-co-butylene adipate) (PBSu-co-bad), poly(tetramethylene succinate) (PTMS), polycaprolactone (PCL), polypropriolactone (PPL), poly(3-hydroxybutyrate) (PHB), poly(3-hydroxybutyrate-co-3-hydroxyvalerate) (PHBV), and mixtures thereof.

In particular, the bicomponent fiber contains two polymer components, selected from polyethylene terephthalate, co-polyethylene terepthalates (Co-PET), polyethylene naphthalate and polybutylene terephthalate.

In an embodiment, the bicomponent fiber comprises polyethylene terephthalate (PET) and co-polyethylene terepthalates (Co-PET) or consists of PET/Co-PET.

In the sense of the present application the term “Co-PET” denotes a copolymer of terephthalic acid, ethane-1,2-diol (ethylene glycol) and at least one further monomer. The further monomer is preferably selected from dicarboxylic acid monomers different terephthalic acid, diol monomers different from ethane-1,2-diol, monomers comprising at least one carboxylic acid and at least one hydroxyl group, wherein the hydroxyl group is polymerizable with carboxylic acid groups, and further monomers and mixtures thereof. Suitable further acid monomers are aromatic, aliphatic and cycloaliphatic dicarboxylic acids. Suitable further aromatic dicarboxylic acid monomers are 2,6-naphthalenedicarboxylic acid and isophthalic acid. Suitable further aliphatic or cycloaliphatic dicarboxylic acids are adipic acid, azelaic acid, sebacic acid, dodecanedioic acids, cyclohexane dicarboxylic acids and mixtures thereof.

Suitable further diol monomers different from ethane-1,2-diol are 1,3-propanediol, 1,4-butanediol, 1,6-hexanediol, 1,4-hexanediol, 1,4-cyclohexanediol, 1,4-cyclohexanedimethylanol, neopentyl glycol and mixtures of thereof.

Accordingly the term “Co-PBT” denotes a copolymer of terephthalic acid, butane-1,4-diol and at least one further monomer. Suitable further diol monomers different from are ethane-1,2-diol are 1,3-propanediol, 1,4-butanediol, 1,6-hexanediol, 1,4-hexanediol, 1,4-cyclohexanediol, 1,4-cyclohexanedimethylanol, neopentyl glycol and mixtures of thereof.

Copolymers of terephthalic acid, ethane 1,2-dioal and butane-1,4-diol can be denoted as Co-PET or Co-PBT, depending on the diol with the higher amount.

Polyesters, in particular polyalkylene terephthalates, like polyethylene terephthalate and co-polyethylene terephthalates, can be prepared by methods known to a person skilled in the art, e.g., by reacting aromatic dicarboxylic acids, or their C₁-C₄ alkyl esters or other ester-forming derivatives (like halogenides or anhydrides), with aliphatic dihydroxy compounds.

Preferably, the fibers forming the core and the fibers forming the shell of the bicomponent fibers are different materials. In particular, fibers forming the core comprise or consist of PET and fibers forming the shell comprise or consist of Co-PET. In particular the ratio of PET:Co-PET is in the range from 90:10 to 40:60.

Polyethylene terephthalate is a copolymer of terephthalic acid and ethane-1,2-diol (also referred to as ethylene glycol). Polyethylene terephthalate is herein also referred to as “PET”. The polyethylene terephthalate can be virgin polyethylene terephthalate (which was not recycled), recycled polyethylene terephthalate (also referred to as “r-PET”), or a mixture of virgin and recycled polyethylene terephthalate. Virgin polyethylene terephthalate can allow for a more precise setting of mechanical properties of the nonwoven laminate. Recycled polyethylene terephthalate can allow for reduced costs of the nonwoven laminate.

The polyethylene terephthalate can confer high homogeneity of mechanical properties of the nonwoven fabric. Thereby, the homogeneity of elongation and tensile strength of the nonwoven fabric can be enhanced. The nonwoven fabric can thereby be easily heated and shaped to provide a desired configuration. The nonwoven fabric can thereby be dimensionally stable when heated and shaped. The polyethylene terephthalate can provide a relatively low basis weight to the layers and the overall laminate, respectively.

The polyethylene terephthalate has a comparably high melting point of about 260° C. The nonwoven fabric can thereby have high heat resistance and nonflammability characteristics. Melting points are herein preferably melting points determined according to DIN ISO 11357-3:2013.

The nonwoven fabric preferably comprises at least one copolyester in form of the used multicomponent fibers. A copolyester is a copolymer of a first dicarboxylic acid monomer and a first diol monomer, together with at least one further comonomer, selected from at least one second different dicarboxylic acid monomer, at least one second different diol monomer and comonomers different therefrom. Suitable copolyester forming monomers are those mentioned for the multicomponent fibers, which are incorporated here by reference.

The nonwoven fabric may also comprise fibers of at least one polyester different from polyethylene terephthalate. Suitable polyester forming monomers and polyesters are those mentioned for the multicomponent fibers. In particular, the polyester is selected from polyethylene naphthalate, polybutylene terephthalate and mixtures thereof.

The nonwoven fabric may also comprise additional fibers of at least one copolyester different from afore-mentioned multicomponent fibers. The additional fibers comprise or consist of a copolyester of a first dicarboxylic acid monomer and a first diol monomer, together with at least one further comonomer, selected from at least one second different dicarboxylic acid monomer, at least one second different diol monomer and comonomers different therefrom. Suitable copolyester forming monomers are those mentioned for the multicomponent fibers, which are incorporated here by reference.

Further suitable multicomponent fibers are selected from at least two polymers, wherein at least one is a polyolefin, in particular polypropylenen homo- or copolymer. A special embodiment is a bicomponent fiber comprising PP and Co-PP. The monomers are etylene and 1,2-butylene.

The copolyester can be an amorphous copolyester, crystalline copolyester or a mixture of at least one amorphous copolyester and at least one crystalline copolyester.

It is preferred that the copolyester is a copolymer of polyethylene terephthalate. A copolymer of polyethylene terephthalate comprises the monomers terephthalic acid, ethane-1,2-diol, and at least one further different dicarboxylic acid monomer and/or at least one further different diol monomer. A preferred further dicarboxylic acid monomer is adipic acid. Another preferred further dicarboxylic acid monomer is isophthalic acid. A preferred further diol monomer is cyclohexane dimethanol. A copolymer of polyethylene terephthalate can ease the recyclability of the nonwoven fabric. A copolymer of polyethylene terephthalate can increase the peel strength within the nonwoven fabric. A copolymer of polyethylene terephthalate can reduce the costs of the raw materials for the nonwoven fabric.

It is preferred that the copolyester has a melting point of ≤240° C. It is more preferred that the copolyester has a melting point of ≤220° C., further preferred of ≤210° C., even more preferred of ≤200° C. and still more preferred of ≤190° C., in particular of =180° C. A copolyester having a melting point of ≤240° C. can reduce the energy required for melt-bonding the layers to each other. A copolyester having a melting point of ≤240° C. can reduce the energy required for producing spunbond layers (A), (C) as defined below. The energy reductions can increase continuously when going to the lower melting points of ≤220° C., ≤210° C., ≤200° C., ≤190° C. and =180° C., respectively.

It is preferred that the copolyester in layers (A), (B) and (C), is basically neutral, i.e. has a pH value of 6.5 to 7.5, more preferably of 6.8 to 7.2, and still more preferably of 7.0. This can avoid undesired chemical interaction of the surfaces of the nonwoven fabric with the environment.

It is preferred that the copolyester has a density of 1.1 to 1.6 g/cm³, more preferably of 1.2 to 1.5 g/cm³, and still more preferably of 1.3 to 1.4 g/cm³. The density is determined according to DIN EN ISO 1183-1:2019-09. Such a density can lead to a nonwoven fabric of appropriate strength, while avoiding excessive costs.

It is more preferred that the copolyester is a copolymer of polyethylene terephthalate and that the copolymer simultaneously has a melting point of ≤240° C. This can lead to a simultaneous increase of peel strength, lowering of costs and lowering of required energy for melt-bonding the layers and for producing the spunbond layers.

Preferably, the binder polymer in multicomponent fibers is selected based on its melting point. In a preferred sheath-core configuration, the core preferably consists of PET and the sheath preferably consists of a copolyester having a melting point of <200° C. One particularly preferred binder fibre has a sheath-core filament configuration. The core consists of PET having a melting point of >250° C., i.e., of about 260° C., and the sheath comprises a copolyester having a lower melting point in the range between 100° C. and 200° C.

Preferably, the multicomponent fibers are bicomponent fibers. A pie-segment filament structure is particularly useful for the multicomponent filaments. Multicomponent filaments are multicomponent staple fibres, and can be present in spunbond nonwoven fabric. Preferably, the multicomponent filament has eight segments alternatingly consisting of PET segments and copolyester segments. It may alternatively have a filament construction from 16, 32 or 64 segments alternatingly consisting of PET segments and copolyester segments. During a moulding process, the low melting copolyester melts and provides rigidity to the material.

A sheath-core filament structure can be useful for spunbond nonwoven fabric as well as for multicomponent staple fibres. The bicomponent filament construction can consist of a sheath of low melting copolymer and of a core of PET having a higher melting point. During a moulding process, the low melting copolyester melts and confers rigidity to the material.

A side-by-side filament structure can be useful for spunbond nonwoven fabric as well as for multicomponent staple fibres. The side-by-side filament construction consists of one side of the low melting copolymer and of another side of PET having a higher melting point. During the moulding process, the low melting copolyester melts and provides rigidity to the material.

The fiber has a cross sectional area hollowness ranging from 2 to 25% based on the total cross sectional area of the fiber. The total cross sectional area of the fiber is the sum of the cross sectional area of the hollowness and the cross sectional area of the remaining fiber.

Preferably, the fiber has a cross sectional area hollowness ranging from 4 to 25% based on the total cross sectional area of the fiber, in particular the cross sectional area hollowness of the multicomponent fibers ranging from 6 to 12% based on the total cross sectional area of the fiber.

In an embodiment, the shape of the hollowness may be a round shape, oval-shape, triangular shape, tetragonal shape, square shape, T-shape, M-shape, S-shape, Y-shape, or H-shape.

In a further embodiment the hollowness has a round shape.

In a preferred embodiment the fiber has only one single hole.

The spunbond nonwoven fabric according to an embodiment of the invention is preferably thermoformable. Thermoforming is a manufacturing process where a nonwoven fabric is heated to a pliable forming temperature, formed to a specific shape in a mold, and trimmed to create a usable product.

The spunbond nonwoven fabric according to an embodiment of the invention has preferably a basis weight (also known as mass per unit area) of 200 to 600 g/m², as determined according to DIN EN 29073-1:1992-08.

The spunbond nonwoven laminate according to an embodiment of the invention has preferably a basis weight (also known as mass per unit area) of 400 to 2000 g/m², as determined according to DIN EN 29073-1:1992-08, based on the total weight of the spunbond nonwoven fabric of all layers.

The spunbond nonwoven fabric according to an embodiment of the invention has preferably a sound absorption coefficient, measured according to DIN ISO 10534-1 (2001) at a wall spacing of 10 mm and at a frequency of 1600 to 2500 Hz, in particular at 2000 Hz, of more than 40%.

In an embodiment of the spunbond nonwoven fabric, the fabric of 100 g/m² has a thermal insulation determined by DIN52612 1979-09 of at least 0.39 W/mK.

### Process:

The hollow multicomponent fiber according to an embodiment of the invention is prepared by melt or solution spinning through spinneret orifices. For melt spinning, a polymer in the molten state can be fed to a spinneret plate, e.g., by means of an extruder. Preferably, one single fiber is formed by a spinneret having a hollow portion. In particular the core is surrounded by PET and the outer core is surrounded by low melting PET which is CoPET. Thus, one single fiber is formed by the combined plasticized polymer melt exiting though the spinneret. In other words, the shape of the fiber is formed by a slot,

Preferably, in the process of an embodiment of the invention the fibers exiting the spinneret are subjected to a one step drawing process (stretching process). For the drawing process, e.g., the newly formed fibers exiting the orifices of the spinneret are first passed through a heated zone, where such a temperature is set as can lead to plastic deformation of the fibers. Subsequent to the heated zone there can be a cooling zone. In this zone the temperature of the fibers is lowered to below the glass transition temperature Tg. Cooling can be carried out in various ways known to the skilled person. When the fiber bundle leaves the cooling zone, the bundle's temperature should be low enough that it can be passed over or along rotating or static guiding elements without the fibers or the bundle being permanently deformed. For drawing, the speed of the fibers (the spinning speed) exiting the spinneret orifices and, if present, the heating and the cooling zone is fixed. The speed can be set to a certain value e.g. by passing the fiber bundle several times across one or more godets. The godets can be heated if desired. By stretching and/or drawing the fibers obtain their final mechanical properties and morphology, in particular their fineness.

In the one-step drawing process according to an embodiment of the invention the fibers (i.e. the as-spun product) are drawn immediately after the spinning speed has been fixed.

In a preferred embodiment of the process of the invention the fibers exiting the spinneret are stretched aerodynamically to obtain the desired strength. The filaments obtained in the spinning process can be deposited forming a nonwoven fabric. E.g. the filaments obtained in the spinning process are deposited on a deposit belt on which they come to lie on top of one another.

In a further preferred embodiment of the process of the invention the spinning process can be performed as melt-blown process in which the melt exiting from the spinnerets is entrained by an air stream at high pressure and high temperature, so that fibers with a low thickness are formed. These fibers can also be deposited to form a nonwoven fabric. This is done primarily on deposit drums.

### Nonwoven Laminate:

In an embodiment, the invention further provides a nonwoven laminate, comprising layers in order (A), (B), (A):
a spunbond nonwoven fabric layer (A), comprising hollow polymeric multicomponent fibers, wherein the spunbond nonwoven fabric has a thickness according to DIN EN ISO 9073-2:1997-02 of at least 1 mm, preferably 1 mm to 25 mm, more preferably 4 mm to 10 mm;
an adhesive layer (B);
a further spunbond nonwoven fabric layer (A) comprising hollow polymeric multicomponent fibers, preferably bicomponent fibers, wherein the spunbond nonwoven fabric has a thickness according to DIN EN ISO 9073-2/1997-02 from at least 1 mm, preferably 1 mm to 25 mm, more preferably 4 mm to 10 mm.

Melt-bonding (thermal bonding) generally refers to a technique of joining polymeric, usually thermoplastic, materials by applying heat, such that at least one material is partially molten or softened, bringing the materials into intimate contact, followed by cooling.

In the nonwoven laminate, layers (A) and also intermediate/adhesive layer (B), are preferably melt-bonded to each other, in particular preferably wherein the layers (A) and (B) are not mechanically bonded to each other. This can be achieved by forming a stack of the layers and melt-bonding the stack. The melt-bonding of all layers to each other can lead to high homogeneity of the heat-shrinking properties of the nonwoven laminates. The high homogeneity of the heat-shrinking properties can reduce the formation of elephant skin during moulding. Due to reduced formation of elephant skin, the nonwoven laminate can have appealing aesthetics and a higher bending strength after moulding. The melt-bonding of the layers to each other can also confer high dimensional stability to the nonwoven laminate when heated and shaped.

Layers (A) comprise polyethylene terephthalate (PET) as defined above.

The adhesive layer (B) comprises or consists preferably CoPET, PP, CoPP, CoPBT in particular the polymer in the adhesive layer (B) has a melting point of ≤20° C.

The nonwoven laminate may consist of layers (A), (B). The nonwoven laminate further may comprises at least one further spunbond nonwoven fabric layer (A), at least one further adhesive layer (B) preferably 1, 2, 3, 4, 5, 6, 7, 8 further nonwoven fabric layers (A), preferably 1, 2, 3, 4, 5, 6, 7, 8 in particular 1, 2, 3, 4, 5 further nonwoven fabric layers (A) and in particular 1, 2, 3, 4, 5 further adhesive layer (B) in the order A, B, A, B, A, B, A, B, A, B. A.

It is preferred that the nonwoven laminate does not contain inorganic reinforcements, in particular not glass fibres. The absence of inorganic reinforcements, in particular of glass fibres, can ease the processability.

It is preferred that the nonwoven laminate does not contain any lofting agent. The absence of any lofting agent makes the nonwoven laminate sustainable. The absence of any lofting agent can lower the costs for an article comprising the nonwoven laminate.

It is preferred that the spunbond nonwoven layer (A) has a basis weight of 300 g/m² to 2000 g/m², as determined according to DIN EN 29073-1:1992-08. For applications in standard passenger cars, it is preferred that layer (A) has a basis weight of 600 to 1500 g/m², more preferably of 700 to 1200 g/m² and most preferably of 800 to 1000 g/m².

It is preferred that the spunbond nonwoven layer (B) has a basis weight according to DIN EN 29073-1:1992-08 of 20 to 200 g/m², more preferably of 30 to 80 g/m². The overall properties can be especially advantageous when such a relatively light weight spunbond layer is included.

It is preferred that the overall nonwoven laminate has a basis weight according to DIN EN 29073-1:1992-08 of 300 to 2000 g/m². Preferably, the nonwoven laminate has a thickness of 2 to 10 mm.

Such a nonwoven laminate can be easily heated and shaped to provide a desired configuration. It can be dimensionally stable when it is heated and shaped. It is suited for structural parts, especially for vehicles. Due to the presence of layer (B), the peel strength and heat resistance can be high.

An embodiment of the invention provides a moulded article comprising the nonwoven laminate according to embodiments of the invention. The moulded article is obtainable by moulding the nonwoven laminate in a form (a “mould”). Typically, moulding is carried out under heat and/or pressure. After or during moulding, the nonwoven laminate is consolidated. Typically, the density is increased and the porosity is decreased, whilst the mechanical stability is increased. The moulded article can be moulded into a defined form and shape. It is typically rigid, such that it can be cut. Overall, a mechanically stable and relatively light-weight article is obtainable, which is suitable for automotive applications, such as underbody shields. Preferably, the moulded part has the shape of the desired automotive part, such as an underbody shield.

In a preferred embodiment, the moulded article is obtained by cold moulding. In the cold mould process, the nonwoven laminate is preferably preheated at a temperature range between 180° C. and 220° C. for 1 to 5 min depending on the basis weight. This is to activate the low melting copolyester which acts as a binder. By activating the binder, it melts and forms a kind of glue between the virgin or recycled PET fibres. It also acts as a glue between the staple fibre nonwoven layers and the spunbond nonwoven layers. After activating, the nonwoven laminate is placed in a compression mould. The compression mould may then compress all or a portion of the nonwoven laminate at a tonnage of 50 tons to 200 tons. The nonwoven laminate is allowed to remain in the mould for up to 60 seconds. The compressed nonwoven laminate is allowed to cool inside or outside the mould to allow the copolyester fibres in the staple fibres and in the spunbond construction to cool below their melting point. Thereafter, the nonwoven laminate is converted to its final shape. For example, the final thickness of the material can be between 2 mm and 6 mm, depending on the requirements of the intended application. The nonwoven laminate is then trimmed as required, which may be achieved by mechanical, thermal or waterjet cutting.

In an embodiment, the present invention provides a moulded article that profits from the advantages of the nonwoven laminate described herein. Particularly pronounced is the effect of reduced formation of elephant skin during moulding and the advantages associated therewith.

It is preferred that the moulded article and/or nonwoven laminate has at least one of the following characteristics:
a bending strength according to ISO 178:2019-04 of ≥250 MPa;
a tensile strength according to ASTM 5034:2009 of ≥500 N; and/or
a tear strength according to DIN EN 29073-3:1992-08 of ≥100 N.

It is more preferred that the nonwoven laminate has a bending strength of ≥250 MPa, even more preferred of ≥300 MPa and still more preferred of ≥400 MPa. It is more preferred that the nonwoven laminate has a tensile strength of ≥500 N, even more preferred of ≥7500 N and still more preferred of ≥950 N. It is more preferred that the nonwoven laminate has a tear strength of ≥100 N, even more preferred of ≥125 N and still more preferred of ≥140 N. The bending strength, tear strength and tensile strength can be adapted by adjusting parameters such as the thickness of layers, fibre type, amount of binder copolymer and consolidation method. Thereby, the mechanical properties of the nonwoven laminate, such as stone-chipping resistance and stability of the material can be further increased.

The nonwoven laminates and moulded articles can be used in the automotive industry, and thus for vehicles, but also for transportation means in general, i.e. for ground, naval or aerospace applications, for example for airplane, ship or railway parts. They are especially suitable for structural parts, especially for vehicles, for which a high stability is required.

The nonwoven laminate or moulded article are especially suitable for exterior applications, preferably for vehicles. Preferred exterior applications are especially those in which high stress and strain is experienced, such as underbody shields, wheel arch liners or engine shields. The use for exterior applications profits from the advantages of the nonwoven laminate and/or moulded article described herein. Particularly pronounced are the effects of enhanced mechanical stability, resistance against stone-chipping and wear resistance, high heat resistance, nonflammability characteristics and acoustic adsorption and the advantages associated therewith.

An embodiment of the invention provides a structural part, preferably for exterior application, comprising the moulded article of embodiments of the invention, preferably for vehicles. The exterior part is preferably an underbody shields, wheel arch liner or engine shield. An embodiment of the invention provides an interior product comprising the moulded article of embodiments of the invention, preferably for vehicles. The interior product is preferably a panel, casing, cladding, reinforcement or boarding. The interior product is preferably for doors, roofs, trunks or seats. An embodiment of the invention provides a vehicle, comprising the moulded article and/or structural part of embodiments of the invention.

In further embodiments, the nonwoven laminates and moulded articles can be used for interior applications, especially for vehicles. Preferred interior applications are panels, casings, cladding, reinforcements or boarding, for example for doors, roofs, trunks or seats. The use for interior applications profits from the advantages of the nonwoven laminate and/or moulded article described herein.

The nonwoven laminate can be produced in a process, comprising:
preparing a spunbond nonwoven fabric/layer (A);
providing in order spunbond nonwoven fabric/layers (A), (B), and (A); and
melt-bonding the layers to each other.

The process for producing the nonwoven laminate profits from the advantages of the nonwoven laminate. Particularly pronounced is the effect of an easy joining of the layers by melt-bonding, which can result in increased peel strength, and the advantages associated therewith.

The overall laminate is formed by establishing a melt-bond, but no mechanical bond, between all layers. Subsequently, the laminate is in the condition for moulding into a desired shape for a particular application. The layered construction is moulded either in a cold mould process or in a hot mould process.

An embodiment of the invention further provides a moulded article comprising a spunbond nonwoven fabric nonwoven according to embodiments of the invention or a laminate according to embodiments of the invention.

Preferably, the moulded article is obtained by cold moulding or hot moulding a spunbond nonwoven fabric according to embodiments of the invention or a nonwoven laminate according to embodiments of the invention. The process of cold moulding or hot moulding are known to the skilled person, and IR moulding is a kind of hot moulding process.

An embodiment of the invention further provides a structural part for vehicles which comprises a moulded article as defined above, wherein the structural part is for example underbody shield, wheel arch liner, engine shield, switchgear units, transformers, especially distribution transformers or power transformers, electrical rotating machines, generators, motors, drives, semiconductive components, power electronics devices, converter stations.

An embodiment of the invention further provides a vehicle comprising a moulded article and/or structural part as defined above.

An embodiment of the invention further provides for the use of a moulded article according to embodiments of the invention as a structural part for vehicles, wherein the structural part is preferably an underbody shield, wheel arch liner or engine shield.

The moulded article and nonwoven laminate solve the problem underlying conventional solutions. The product has high mechanical stability and good acoustic properties, recyclability, low weight and low heat shrinking, and shows reduced elephant skin effect. Moreover, the material has a high resistance against stone-chipping. Accordingly, the nonwoven composites and moulded articles are highly suitable for applications in the automotive, marine, aerospace and rail vehicle sector. The nonwoven composites and moulded articles are in particular suitable for structural parts and/or exterior applications, especially for vehicles, such as underbody shields, wheel arch liners or engine shields. The materials are available at low costs and can be produced and shaped in a convenient and simple method.

### Example 1

Spunbond fabric comprising bicomponent fibers produced by using a special spinneret, wherein the bicomponent fibers have a hollow portion in the core (=inner core) surrounded by PET (=outer core) and the outer core being surrounded by a low melting PET polymer, which is a Co-PET. The PET forming the outer core has a melting point of 255° C. and the Co-PET forming the shell has a melting point of 223° C. The ratio of PET:Co-PET in the cross-section is 60:40 and the amount of hollow portion is the core is 8%.

Table 1 shows the comparison of the mechanical properties of the spunbond fabric according to an embodiment of the invention comprising hollow polymeric multicomponent fibers with that of a 100% needle punched staple fiber fabric, comprised of 50 wt % PET (6,7dTex, 67 mm) and 50 wt % PET:Co-PET (4,4dTex, 51 mm).

TABLE 1

| | | | | Hollow BiCo |
|---|---|---|---|---|
| | | | | (according to an |
| | | | 100% Staple | embodiment |
| | | Standard | Fiber | of the |
| Properties | Unit | (Norm) | (Comparison) | invention) |
| Basis Weight | g/m² | DIN EN 29073-1 | 1350 | 1241 |
| Thickness | mm | DIN 9073-2 | 4 | 4 |
| Bending | MPa | ISO 178 | 121 | 302 |
| Strength | | | | |
| Thermal | W/mK | DIN 52612 | 0.046 | 0.0393 |
| Conductivity | | | | |
| Tensile | N | ASTM 5034 | 990 | 1426 |
| Strength | | | | |
| Tear Strength | N | DIN EN 29073-3 | 146 | 198 |

Results of example 1 show that the lofted spunbund fabric comprising hollow polymeric multicomponent fibers according to embodiments of the invention have significantly better mechanical properties than 100% needle punched staple fiber fabric. Even though the staple fiber fabric has a higher amount of Co-PET, the mechanical properties are inferior to that of the endless spunbond fabric according to embodiments of the invention. The 8% hollow portion contributes for better thermal insulation than its comparison.

### Example 2

Spunbond fabric comprising bicomponent fibers produced by using a special spinneret, wherein the bicomponent fibers have a hollow portion in the core (=inner core) surrounded by PET (=outer core) and the outer core being surrounded by low melting PET polymer which is a Co-PET. The PET forming the outer core has a melting point of 223° C. and CoPET has the melting point of 255° C. and respectively. The ratio of PET:CoPET in the cross-section is 80:20 and the amount of hollow portion of the core is 6%.

Table 2 shows the comparison of the mechanical properties of the spunbond fabric according to an embodiment of the invention comprising hollow polymeric multicomponent fibers with that of a 100% needle punched staple fiber fabric, comprised of 50% PET (6,7dTex, 67 mm) and 50 wt. % PET:Co-PET (4,4dTex, 51 mm), and spunbond fabric comprising hollow polymeric multicomponent fibers.

TABLE 2

| | | | | Hollow BiCo |
|---|---|---|---|---|
| | | | | (according to an |
| | | | 100% Staple | embodiment |
| | | | Fiber | of the |
| | | Standard | (Comparison) | invention) |
| Properties | Unit | (Norm) | sample) | invention) |
| Basis Weight | g/m2 | DIN EN 29073-1 | 1350 | 1250 |
| Thickness | mm | DIN 9073-2 | 4 | 4 |
| Bending | MPa | ISO 178 | 121 | 286 |
| Strength | | | | |
| Thermal | W/mK | DIN 52612 | 0.046 | 0.041 |
| Conductivity | | | | |
| Tensile | N | ASTM 5034 | 990 | 1287 |
| Strength | | | | |
| Tear Strength | N | DIN EN 29073-3 | 146 | 177 |

Results of example 2 show that the lofted spunbond hollow bicomponent fiber fabric according to embodiments of the invention have significantly better mechanical properties than 100% needle punched staple fiber fabric. Even though the staple fiber fabric has a high amount of Co-PET, the mechanical properties are inferior to that of the endless spunbond hollow bicomponent fiber fabric. The 6% of hollow portion contributes for better thermal insulation than its comparison.

### Example 3

Spunbond fabric comprising bicomponent fibers produced by using a special spinneret, wherein the bicomponent fibers have a hollow portion in the core (=inner core) surrounded by PET (=outer core) and the outer core being surrounded by a low melting PET polymer, which is a Co-PET. The PET forming the outer core has a melting point of 255° C. and the Co-PET forming the shell has a melting point of 223° C. The ratio of PET:Co-PET in the cross-section is 60:40 and the amount of hollow portion is the core is 8%.

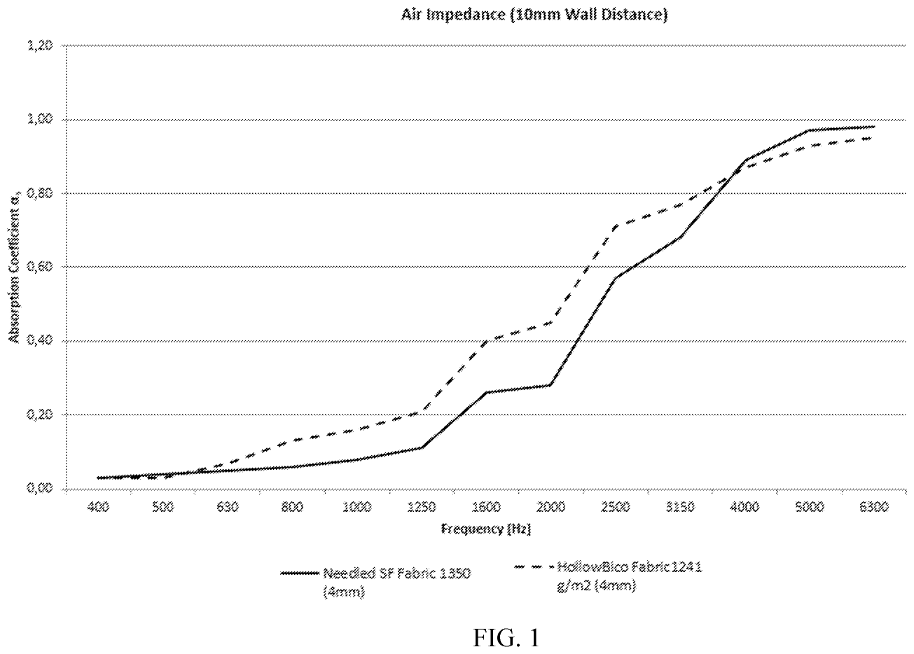

FIG. 1 shows the comparison of the acoustic absorption (DIN ISO 10534-1) between needled staple fabric and hollow Bico Spunbond fabric according to embodiments of the invention.

Acoustic curves show better absorption in low and medium frequency areas for hollow bicomponent spunbond fabric than staple fiber fabric. This is very important for the use of material in automotive applications.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A spunbond nonwoven fabric, comprising:
hollow polymeric multicomponent fibers,
wherein the spunbond nonwoven fabric has a thickness according to DIN EN ISO 9073-2:1997-02 of at least 1 mm.

2. The spunbond nonwoven fabric according to claim 1, having a thickness according to DIN 9073-2/1997 in the range of 1 to 25 mm.

3. The spunbond nonwoven fabric, according to claim 1, wherein the hollow polymeric multicomponent fibers comprise hollow bicomponent fibers.

4. The spunbond nonwoven fabric according to claim 1, wherein a cross sectional area hollowness of the multicomponent fibers is in a range from 4 to 25% based on a total cross sectional area of the fibers.

5. The spunbond nonwoven fabric according to claim 1, wherein the hollow polymeric multicomponent fibers contain at least two polymer components selected from two different polyesters.

6. The spunbond nonwoven fabric according to claim 5, wherein the polyesters are selected from polyethylene terephthalate (PET), co-polyethylene terepthalates (Co-PET), polyethylene naphthalate, polybutylene terephthalate, co-butylene terephthalate, polylactic acid, poly(ethylene succinate), poly(butylene succinate), poly(ethylene adipate), poly(butylene succinate-co-butylene adipate), polyhydroxyacetic acid, poly(butylene succinate-co-butylene sebacate), poly(butylene succinate-co-butylene adipate), poly(tetramethylene succinate), polycaprolactone, polypropriolactone, poly(3-hydroxybutyrate), poly(3-hydroxybutyrate-co-3-hydroxyvalerate), and mixtures thereof.

7. The spunbond nonwoven fabric according to claim 6, wherein the hollow polymeric multicomponent fibers contain PET/Co-PET and the ratio of PET:Co-PET is in a range from 90:10 to 40:60.

8. The spunbond nonwoven fabric according to claim 1, wherein the nonwoven fabric is thermoformable.

9. The spunbond nonwoven fabric according to claim 1, wherein the nonwoven fabric has a basis weight of 200 to 600 g/m², as determined according to DIN EN 29073-1:1992-08.

10. The spunbond nonwoven fabric according to claim 1, having a sound absorption coefficient, measured according to DIN ISO 10534-1 at a wall spacing of 10 mm and at a frequency of 1600 to 2500 Hz of more than 40%.

11. The spunbond nonwoven fabric according to claim 1, wherein a fabric of 100 g/m² has a thermal insulation, determined by DIN 52612 1979-09, of at least 0.39 W/mK.

12. A method for preparing the spunbond nonwoven fabric according to claim 1, wherein hollow multicomponent fibers are employed, the method comprising:
preparing the spunbond nonwoven fabric by melt or solution spinning of the hollow multicomponent fibers through a spinneret comprising a pattern of orifices,
forming one single fiber by passing the polymer melt through a spinneret having a hollow portion, and
subjecting the fibers exiting the spinneret to a one step drawing process.

13. A nonwoven laminate, comprising:
layers in an order of (A), (B), (A),
wherein layer (A) is a spunbond nonwoven fabric layer including hollow polymeric multicomponent fibers, the spunbond nonwoven fabric having a thickness according to DIN EN ISO 9073-2:1997-02 of at least 1 mm, and
wherein layer (B) is an adhesive layer.

14. The nonwoven laminate according to claim 13, wherein the layers (A) and (B) are melt-bonded to each other.

15. The nonwoven laminate according to claim 13, wherein the adhesive layer, comprises Co-PET, PP, Co-PP, Co-PBT, and a polymer in the adhesive layer has a melting point of less than 240° C.

16. The nonwoven laminate according to claim 13, wherein the nonwoven laminate has a basis weight of 300 g/m² to 2000 g/m², as determined according to DIN EN 29073-1:1992-08.

17. The nonwoven laminate according to claim 13, wherein the laminate further comprises at least one further spunbond nonwoven fabric layer, at least one further adhesive layer.

18. A moulded article comprising the spunbond nonwoven fabric according to claim 1.

19. A structural part for vehicles, comprising the moulded article of claim 18.

20. A vehicle, comprising the moulded article according to claim 18.

21. The moulded article according to claim 18, wherein the moulded article is configured for arrangement in an automobile, marine vehicle, aerospace vehicle, or rail vehicle.
